(19) United States
(12) Patent Application Publication
(10) Pub. No.: US 2026/0269640 A1
(43) Pub. Date: Sep. 10, 2026

(54) A SYSTEM FOR CHARGING AN AUDIO DEVICE

(71) Applicant: Niharika PUTHAMAKULA, Bangalore (IN)

(72) Inventor: Niharika PUTHAMAKULA, Bangalore (IN)

(21) Appl. No.: 19/165,156

(22) PCT Filed: Sep. 5, 2023
(86) PCT No.: PCT/IB2023/058766

§ 371 Date: Sep. 15, 2025

(30) Foreign Application Priority Data
Mar. 16, 2023 (IN) 202341017755

(51) Int. Cl. H02J 7/70; H04R 1/10; H04R 1/1025

(52) U.S. Cl. CPC H02J 7/751; H04R 1/1025; H04R 1/1033; H04R 1/1041; H02J 2207/30; H04R 2420/07

(57) ABSTRACT

The present disclosure explains a system for charging an audio device. The system comprises the following. A wireless audio device including a left ear piece (101a) and a right ear piece (101b), wherein the left ear piece (101a) and the right ear piece (101b) can include a rechargeable battery (103) for supplying power. A charging port (105) is configured in the left ear piece (101a) and the right ear piece (101b) and connected to rechargeable battery (103). A charging extender (107) is operatively connected to the charging port (105) for charging the rechargeable battery (103) during usage of the audio device (101).

### FIELD

The embodiments herein generally relate to wireless audio devices. More particularly, the disclosure relates to a system for charging wireless headphones and earpods.

### BACKGROUND AND PRIOR ART

Headphones and ear pods are one of the most commonly used audio devices for listening, communicating on a mobile phone or any other electronic device. Specifically, wireless audio devices including Bluetooth headphone and earpods have become widely prevalent due to their advantage of providing a hassle free experience to the users.

However, these Bluetooth audio devices need to be charged frequently as their batteries cannot sustain continuous usage for a longer duration. The existing Bluetooth ear pods are generally charged in the ear pod case and the Bluetooth headphones are charged using a charger. In both the above mentioned situations, the audio devices cannot be used during the complete span of charging. Due to this, the existing Bluetooth audio devices cause inconvenience to the users during low charge, as the devices do not function without sufficient charge and the devices cannot be used during charging. Further, the wireless audio devices are widely used by students and professionals leading to problematic consequences during important circumstances.

Therefore, there is a need for a system of charging wireless audio devices during usage. Moreover, there is a need for a cost effective and compact wireless system for charging Bluetooth based headphones and earpods during usage.

### OBJECTS

Some of the objects of the present disclosure are described herein below:

The main objective of the present disclosure is to provide a system for charging wireless audio devices.

Another objective of the present disclosure is to provide a system for charging Bluetooth based headphones and ear pods during usage.

Still another objective of the present disclosure is to provide a compact and an economical system for charging wireless audio devices.

Yet another objective of the present disclosure is to provide a wireless system for charging Bluetooth ear pods and headphones.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a system for charging an audio device.

In accordance with an embodiment, the system for charging an audio device comprises a left ear piece and a right ear piece of the wireless audio device; wherein the left ear piece and the right ear piece include a rechargeable battery for supplying power. A charging port is configured in the left ear piece and the right ear piece and connected to rechargeable battery and a charging extender is operatively connected to the charging port for charging the rechargeable battery during usage of the audio device. In an embodiment, the charging port is a magnetic mechanism operatively connected to the charging extender for charging the rechargeable battery.

In an embodiment, the audio device includes but not limited to one of a wireless Bluetooth headphone, wireless Bluetooth ear pods and wireless Bluetooth earphones. In an embodiment, the charging extender is a battery.

In accordance with an embodiment, the charging extender is placed in the magnetic mechanism of the left ear piece and the right ear piece for charging rechargeable battery wirelessly.

In accordance with an embodiment, the magnetic mechanism includes a plurality of magnetic plates for connecting to the charging extender by means of magnetism.

In accordance with an embodiment, the system includes two cables configured with a magnetic mechanism at a first end and a magnetic mechanism at a second end and the magnetic mechanism provided at the first end of the cables is coupled to the magnetic mechanism of the left ear piece and the right ear piece of the audio device.

In another embodiment, the magnetic mechanism at the second end of the cables is connected to ends of the charging extender for facilitating charging of rechargeable battery.

In another embodiment, the magnetic mechanism at the second end of the cables is connected to an USB adaptor and the USB adaptor is connected to an external power source for charging rechargeable battery. In an embodiment, the external power source includes but not limited to one of a mobile phone, laptop, electronic communication device, power bank.

In another embodiment, the audio device is a wireless headphone, wherein a recharger accommodated in a second portion of the left ear piece and the right ear piece and wherein the recharger connected to the charging port for charging the rechargeable battery of the head phone. In an embodiment, a switch is provided on the recharger capable of switching ON and/or switching OFF to start and/or stop the charging of the rechargeable battery. In an embodiment, the recharger is connected to the rechargeable battery by one of mechanical means and magnetic means.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1a illustrates a schematic of a system for charging an audio device, according to an embodiment herein;

FIG. 1b illustrates a schematic of a system for charging an audio device, according to an embodiment herein;

FIG. 2 illustrates a schematic of a system for charging an audio device, according to another embodiment herein;

FIG. 3 illustrates a schematic of a system for charging an audio device, according to another embodiment herein;

FIG. 4a illustrates a perspective view of an audio device, according to another embodiment herein;

FIG. 4b illustrates a side view of the audio device, according to another embodiment herein;

FIG. 5a illustrates a front view of the audio device without the recharger, according to another embodiment herein;

FIG. 5b illustrates a front view of the audio device of FIG. 4a, according to another embodiment herein;

FIG. 5c illustrates a front view of the audio device of FIG. 4b, according to another embodiment herein.

### LIST OF NUMERALS

101—Audio device
101a—Left ear piece
101b—Right ear piece
103—Rechargeable battery
105—Charging Port
106—Ends
107—Charging extender
201—Cable
203a—Magnetic mechanism at first end
203b—Magnetic mechanism at second end
301—USB adaptor
401a—First portion
401b—Second portion
402—Recharger
403—Switch

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

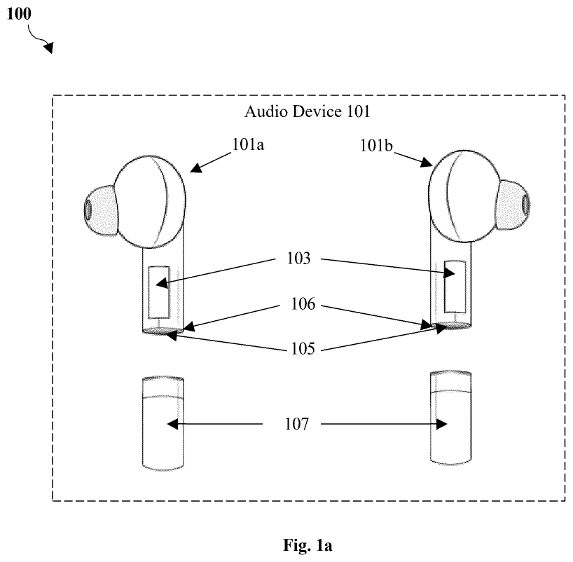

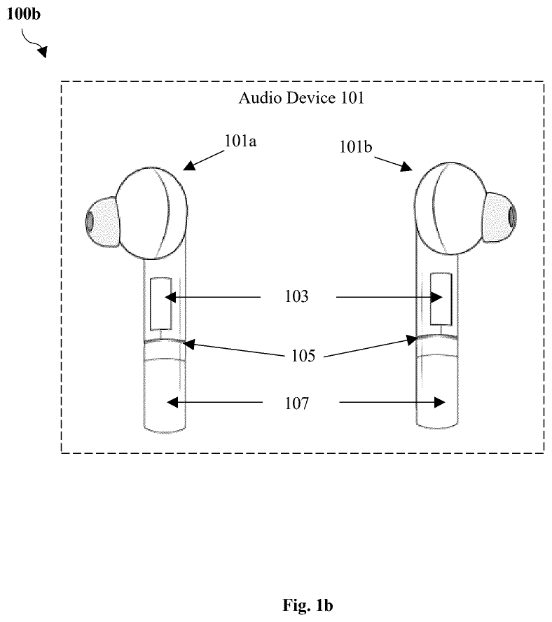

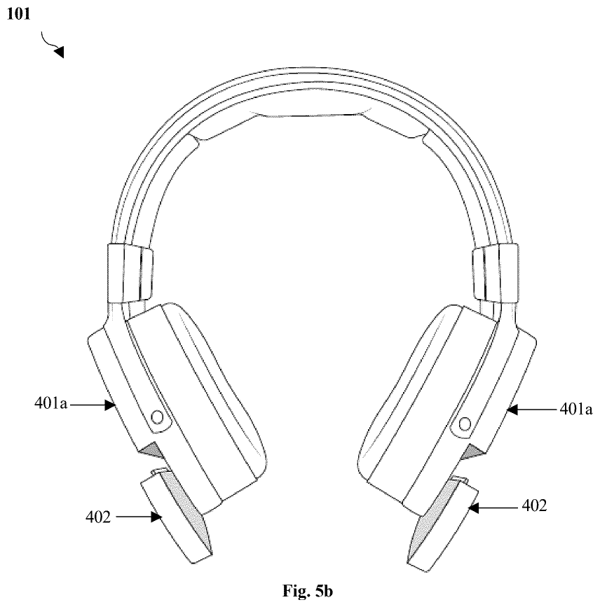

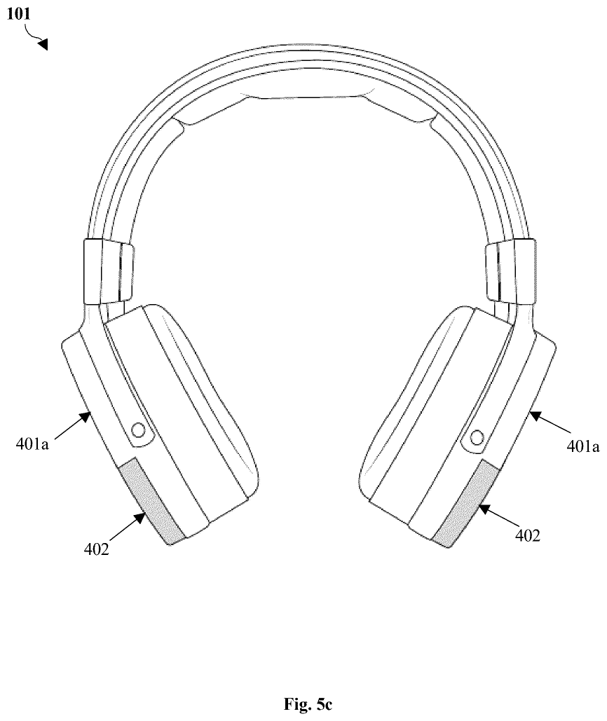

As mentioned above, there is a need for a system of charging wireless audio devices during usage. In particular, there is a need for a cost effective and compact wireless system for charging Bluetooth based headphones and earpods during usage. The embodiments herein achieve this by providing “A system for charging an audio device”. Referring now to the drawings and more particularly to FIG. 1 and FIG. 5c, where similar reference characters denote corresponding features consistently throughout the figures, there are shown preferred embodiments.

FIG. 1a illustrates a schematic of a system for charging an audio device. In an embodiment, the system includes a wireless audio device 101, a magnetic mechanism 105 and a charging extender 107.

The wireless audio device 101 can include a left ear piece 101a and a right ear piece 101b. In an embodiment, the wireless audio device 101 can include but not limited to a wireless Bluetooth headphone, a wireless Bluetooth earphones and wireless Bluetooth earpods.

In an embodiment, the left ear piece 101a and the right ear piece 101b of the audio device 101 can include at least one rechargeable battery 103. The rechargeable battery 103 is capable of being charged and reused.

In an embodiment, a charging port 105 can be configured inside the left ear piece 101a and the right ear piece 101b of the audio device 101. In an embodiment, the charging port 105 is the point for charging the rechargeable battery 103 using the charging extender 107. The charging port 105 can either use a magnetic mechanism or mechanical mechanism. The purpose of charging port 105 is solely to connect the rechargeable battery 105 and charging extender 107. In a preferred embodiment, the charging port 105 is configured at an end 106 of the left ear piece and right ear piece of the audio device. The charging port 105 can be connected to the rechargeable battery inside the left ear piece and the right ear piece of the audio device 101 as well.

In an embodiment, the charging port 105, if using magnetic mechanism, can include a magnetic latch. The magnetic latch can include but not limited to magnetic plates placed inside the left ear piece and the right ear piece.

In an embodiment, the charging extender 107 is configured for charging the rechargeable battery 103 inside the left ear piece 101a and the right ear piece 101b. In an embodiment, the charging extender 107 can be configured for connecting to the charging port 105 by magnetic mechanism or mechanically. In a preferred embodiment, the charging extender 107can be connected by being placed inside or in connectivity with the charging port 105 of the left ear piece and the right ear piece of the audio device, through charging port 105.

In an embodiment, the charging extender 107 can include but not be limited to a battery. In a preferred embodiment, the battery of the charging extender 107 can form a parallel circuit with the rechargeable battery 103 for performing charging. Thereby, the charging extender 107 can facilitate wireless charging of rechargeable battery 103 in the left ear piece 101a and the right ear piece 101b during usage of the audio device.

FIG. 1b illustrates a schematic of a system for charging an audio device. In an embodiment, the charging extender 107 connected with the charging port 105 of the left ear piece and the charging port 105 of the right ear piece of the audio device.

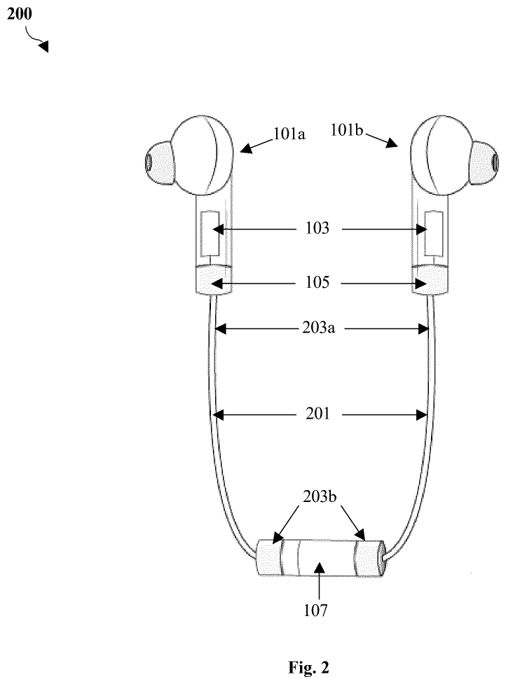

FIG. 2 illustrates a schematic of a system for charging an audio device, according to another embodiment. The system includes two cables 201. In an embodiment, the cable 201 can include a first end and a second end. Either a magnetic mechanism or a mechanical/manual mechanism/connection can be configured at the first end (203a) and second end (203b) of the cable 201.

In an embodiment, the magnetic mechanism or mechanical/manual connection 203a at the first end of the cables 201 can be configured for connecting to the charging port 105 in the left ear piece 101a and the right ear piece 101b of the audio device. In an embodiment, the magnetic mechanism or mechanical/manual connection 203b at the second end of the cables 201 can be configured for connecting to the charging extender 107. The charging extender 107 can be configured for charging the rechargeable batteries 103 through the cables 201 during usage of the audio device.

In an embodiment, the magnetic mechanism or mechanical/manual connection 203a of the cables 201 can be placed inside the charging port 105 of the left ear piece and the right ear piece or be attached/connected to the end 106 at charging port 105 by means of magnetism or manually/mechanically. The cables 201 can facilitate charging of both the left ear piece and the right ear piece using a single charging extender 107.

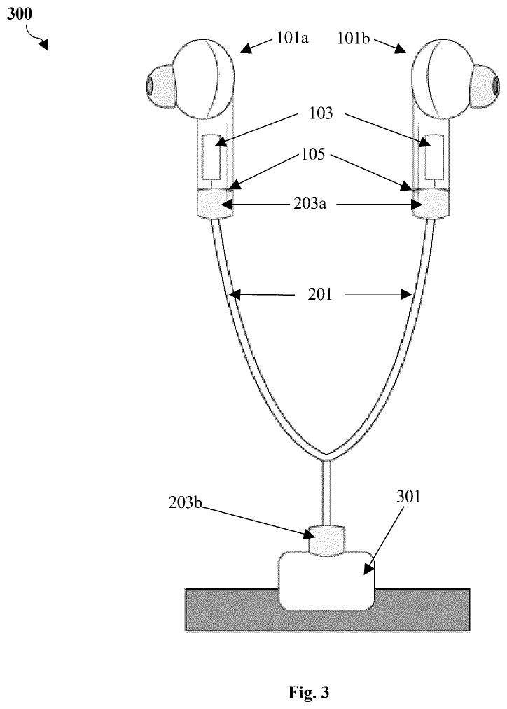

FIG. 3 illustrates a schematic of a system for charging an audio device according to another embodiment.

In an embodiment, the magnetic mechanism 203b at the second end of the cables 201 can be configured for connecting to an USB adaptor 301. The USB adaptor 301 can be configured for connecting to an external power source for charging the rechargeable batteries 103 through the cables 201 during usage of the audio device.

In an embodiment, the external power source can include but not limited to mobile phone, smart phone, laptop, notebook and an electronic communication device.

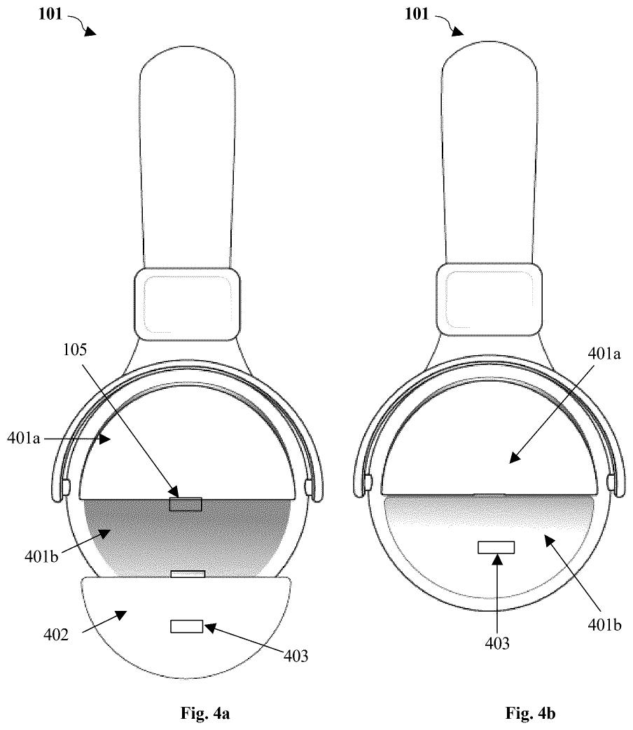

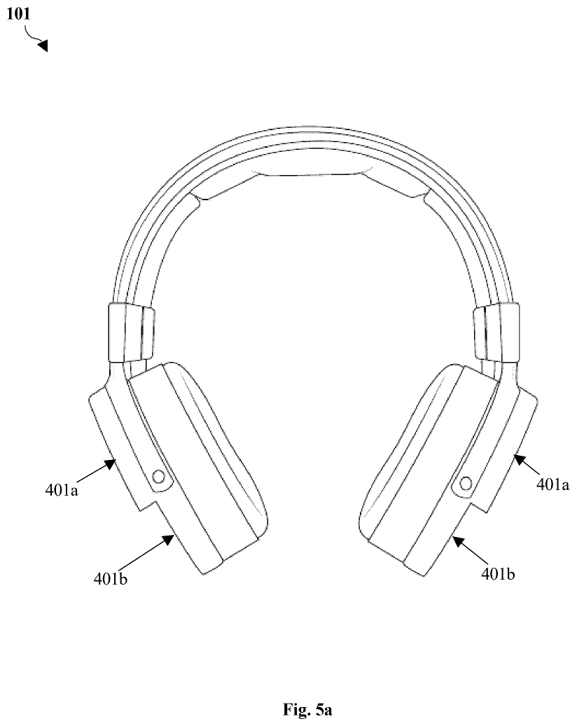

FIG. 4a illustrates a side view of an audio device, according to another embodiment. In an embodiment, the audio device is a wireless headphone. In an embodiment, the headphone includes the left ear piece and the right earpiece. The left ear piece and/or the right ear piece include a first portion 401a and a second portion 401b. The charging port 105 is provided on the left ear piece and/or the right ear piece for facilitating charging of the rechargeable battery (not shown in figure) provided in the left ear piece and/or the right ear piece

In an embodiment, the second portion 401b is hollow for accommodating a recharger 402. In an embodiment, the recharger 402 is provided for mounting on the second portion 401b of the left ear piece and the right ear piece. The recharger 402 is configured for being connected to the charging port 105. Recharger 402 can be connected to charging port 105 by either magnetic mechanism (not shown in image) or through mechanical/manual connection. In an embodiment, a switch 403 is provided on the recharger 402 for controlling charging of the rechargeable battery. The switch 403 is capable of being switched on and/or switched off for starting and/or stopping the charging of the rechargeable battery. Such that, when switch 403 is switched off, then recharger 402 would not charge rechargeable battery in first portion 401a. When switch 403 is on, then recharger 402 will charge the rechargeable battery in first portion 401a even during usage. In an embodiment, the recharger 402 includes but is not limited to a power bank. In an embodiment, the recharger 402 facilitates charging of the left ear piece and the right ear piece of the head phone during usage.

FIG. 4b illustrates a side view of the audio device. The recharger 402 is connected to the charging port 105, wherein the recharger 402 is positioned in the second portion 401b. The recharger 402 facilitates powering the left ear piece and the right ear piece and charging the left ear piece and the right ear piece during both when the headphone is left idle and also during usage of the headphone.

FIG. 5a illustrates a front view of the audio device without the recharger. In an embodiment, the headphone 101 includes the second portion 401b for facilitating positioning of the recharger.

FIG. 5b illustrates a front view of the audio device of FIG. 4a. In an embodiment, the recharger 402 is being positioned in the second portion 401b for being connected to the charging port on the first portion 401a.

FIG. 5c illustrates a front view of the audio device of FIG. 4b. In an embodiment, the recharger 402 is connected to the charging port 105 and positioned in the second portion 401b for powering and charging the headphone.

A main advantage of the present disclosure is that the system provides wireless charging of the audio devices.

Another advantage of the present disclosure is that the system provides wireless charging of Bluetooth headsets and ear pods during usage.

Still another advantage of the present disclosure is that the system for charging of audio devices is compact and economical.

Yet another advantage of the present disclosure is that the system for charging of audio devices facilitates continuous and uninterrupted usage of the audio devices.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A system for charging an audio device (101), comprising:
a left ear piece (101a) and a right ear piece (101b) of the wireless audio device (101);
wherein the left ear piece (101a) and the right ear piece (101b) including a rechargeable battery (103) for supplying power;
a charging port (105) configured in the left ear piece (101a) and the right ear piece (101b) and connected to rechargeable battery (103);
characterized in that a charging extender (107) operatively connected to the charging port (105) for charging the rechargeable battery (103) during usage of the audio device (101); and
the charging port (105) is a magnetic mechanism (105) operatively connected to the charging extender (107) for charging the rechargeable battery (103).

2. The system as claimed in claim 1, wherein the charging extender (107) is a battery.

3. The system as claimed in claim 1, wherein the charging extender (107) placed in the magnetic mechanism (105) of the left ear piece (101a) and the right ear piece (101b) for charging rechargeable battery (103) wirelessly.

4. The system as claimed in claim 1, wherein the magnetic mechanism (105) including a plurality of magnetic plates for connecting to the charging extender (107) by means of magnetism.

5. The system as claimed in claim 1, wherein the system includes two cables (201) configured with a magnetic mechanism (203a) at a first end and a magnetic mechanism (203b) at a second end; and
wherein the magnetic mechanism (203a) provided at the first end of the cables (201) coupled to the magnetic mechanism (105) of the left ear piece (101a) and the right ear piece (101b) of the audio device (101).

6. The system as claimed in claim 5, wherein the magnetic mechanism (203b) at the second end of the cables (201) connected to ends of the charging extender (107) for facilitating charging of rechargeable battery (103).

7. The system as claimed in claim 5, wherein the magnetic mechanism (203b) at the second end of the cables (201) connected to an USB adaptor (301); and wherein the USB adaptor (301) connected to an external power source for charging rechargeable battery (103).

8. The system as claimed in claim 7, wherein the external power source including one of a mobile phone, laptop, electronic communication device, power bank.

9. The system as claimed in claim 1, wherein the audio device (101) is a wireless headphone;
wherein a recharger (402) accommodated in a second portion (401b) of the left ear piece (101a) and the right ear piece (101b); and
wherein the recharger (402) connected to the charging port (105) for charging the rechargeable battery (103) of the head phone.

10. The system as claimed in claim 9, wherein a switch (403) provided on the recharger (402) capable of switching ON and/or switching OFF to start and/or stop the charging of the rechargeable battery.

11. The system as claimed in claim 9, wherein the recharger (402) connected to the rechargeable battery by one of mechanical means and magnetic means.

12. The system as claimed in claim 1, wherein the audio device (101) including one of a wireless Bluetooth headphone, wireless Bluetooth ear pods and wireless Bluetooth earphones.
